(19) United States
(12) Patent Application Publication
(10) Pub. No.: US 2012/0259668 A1
(43) Pub. Date: Oct. 11, 2012

(54) SYSTEM AND METHODS FOR INTEGRATING FAN EXPERIENCES USING SMART DEVICE TECHNOLOGY

(76) Inventor: Timothy LeBeau, Venice, CA (US)

(21) Appl. No.: 13/441,590

(22) Filed: Apr. 6, 2012

Related U.S. Application Data
(60) Provisional application No. 61/473,041, filed on Apr. 7, 2011.

(51) Int. Cl. G06Q 30/00; G07B 15/00; G06Q 30/06; G06Q 30/02; G06Q 10/00; G06Q 10/02

(52) U.S. Cl. 705/5; 705/1.1; 705/26.1; 705/26.61; 705/14.1; 705/13; 705/14.27; 705/14.33

(57) ABSTRACT

A holistic and integrated system that utilizes smart phone and similar technology to enhance the experience of a consumer of goods, services, and/or entertainment as it relates to sporting, music, dining, and gambling activities. This solution is the combination of a smart phone device and similar mobile computing device with a connection that facilitates activities digitally that have commonly been executed using other means. Once a consumer enters into the ecosystem, they can participate in a virtual social media playground that allows them to order goods or services as well as participate in a competitive game atmosphere. The consumer will gain recognition and awards based on their frequency of visits, the amount of money spent, their participation in games, as well as other activities. The awards can be traded for virtual or actual goods, merchandise, or services at a later date.

### CROSS-REFERENCE TO RELATED APPLICATION

This application claims priority to U.S. Provisional Application No. 61/473,041, filed Apr. 7, 2011, which is incorporated herein by reference in its entirety.

### TECHNICAL FIELD

This invention relates generally to the discovery, offer and sale of goods and services, and more specifically to the method of ordering and receiving the good or service. The invention works on a network, such as the internet, wherein the user registers themselves and creates an avatar for themselves. The avatar then acts as a virtual fan, performing activities that could usually be performed by the individual in person or not at all.

The present invention contemplates a reward or loyalty program that is used to facilitate increased consumption and builds a relationship between the facilities management and the consumer. In the program, consumers are encouraged to collect points, which can then be redeemed for awards. Among other ways points can be collected, they can be based on the price of the good or service or if it was purchased during a special offer time.

Information about the customer can be obtained in numerous ways, including a profile that is set up by the consumer, from scanning an identification card or via a social network profile. Once the details about the consumer are identified and created, their patterns are tracked and enable relevant advertising, specials and increasingly relevant suggestions.

### BACKGROUND OF THE INVENTION

Currently, there are many inefficiencies to being a fan. These inefficiencies include waiting in line, printing tickets and receipts on paper, etc. Also, a fan known as the fan-tom is treated the same by the facility and the team no matter if they come to one event or every game or if they have spent zero or a high amount of money at the events.

There is currently no system that integrates all of the activities that a consumer of entertainment would utilize. Many of the individual activities that are contained within this invention exists independently, or with using physical activities to execute, this invention combines these activities and makes them controllable from a smart phone or similar technologies.

### SUMMARY OF THE INVENTION

The present invention is a system and method of connecting the fan with the venue and event that will mutually satisfy the consumer with goods and services and the vendor with an increased amount of consumption, awareness and loyalty.

The present invention is a technology integrator that allows unlimited access to goods and services by the user as well as a unique way for the event manager to establish a relationship with the user. The system uses a game layer that interacts with the behavior of the consumer to improve the fan experience. This system is designed so that it introduces these dynamics into the environment by attaching them to the normal operations of a fan or consumer. The system starts by creating an avatar for the user. This avatar is a representative of the consumer within the game layer. This avatar allows the user to check into a location, earn points and compete against other user's avatars in games and challenges. This system also creates the ability to facilitate commerce over the network, linking into existing ticket, concession, merchandise, etc sales.

Once the purchases have been made or activities complete, the consumer receives points depending on the amount spent or the activity. These points are used to achieve a level of recognition and social status. These rewards can be traded for goods of both virtual and real nature. Recognition can be given for money spent, games won, how many times at a venue or event etc. Once a certain level of points is accumulated, the fan will receive a status associated with the points earned. These profiles will also allow the event or venue manager to target marketing activities to the consumers that coincide with their activities.

Consumers can also sign up to receive an email when a deal is available or new service is announced. An example of this would be the “12 o'clock shadow” an offer that will go out at noon on the day of the event to offer promotional packages that will drive more ticket sales and overall consumption.

For the purpose of this application, the loyalty or reward points are collected and can be used for virtual goods like gear for the avatar or for real goods like parking, tickets, merchandise etc.

Further, consumers can be rewarded for other actions that are tied to the team, venue or event. This includes, but not limited to consumption at the venue, but points can be earned by participating in sponsors activities. This can include challenges where the sponsor's logo is used, attending a bar after the event etc.

It is also contemplated that various terms of the points can be defined such as expiration and award. It is contemplated that the points may either expire within a certain time frame or are good until redeemed. The award may either be monetary or non monetary, virtual or real. The award further includes customized levels at which points can be collected as well as customized levels at which points can be redeemed. For example, one point can be collected for every dollar spent. As another example 1.5 points can be collected for every dollar spent if the consumer has achieved a level determined by previous activities and or spend. Points can then be exchanged for goods or services in a virtual or real store that is pre-designated.

Information about the consumer can be obtained in numerous ways, including a consumer profile that is set up by the consumer, by scanning an identification card or by connecting to an existing profile on a social media venue. Once information about the consumer is known, the user may allow the information to be used or may decide to opt out of this portion. It can also be used to build a profile of the consumer's behaviors and then suggest goods or services that the consumer may be interested in for the future. This will facilitate relevant offers and marketing.

An object of the present invention is to provide the consumer an easy way to order goods and services that they would be interested in ordering.

Another object of the present invention is to provide recognition to the consumer for behaviors or activities that they participate in. This can be done in many ways including VIP entrances, upgrades, concierge services, on screen recognitions, becoming the “leader” of the section etc.

Another object of the present invention is to provide a way of discovering and becoming informed of goods and services that are available as a result of a profile.

Another object of the present invention is to provide additional incentives to link to other activities that the consumer may be interested in.

Another object of the present invention is to provide incentives that would increase consumption.

Another object of the present invention is to provide the event manager a better understanding of their consumer, their demographics and behavior. As well as it will establish a better relationship between the fan and the provider.

Another object of the present invention is to provide an exchange program where consumers can exchange their loyalty points for goods and services.

### BRIEF DESCRIPTION OF THE DRAWINGS

The drawings show how the consumer will use a connected smart phone to navigate through the super fan application. The preferred embodiments of the invention will be described in conjunction with the appended drawings provided to illustrate and not limit the invention, where like designations denote like elements, and in which:

FIG. 1 illustrates a flow chart in accordance with one embodiment of the present invention;

FIG. 2 illustrates a flow chart that shows how an application is downloaded on a phone of the present invention;

FIG. 3 illustrates a flow chart that describes how a user enters their personal information;

FIG. 4 illustrates a flow chart that shows the home screen;

FIG. 5 illustrates a flow chart that shows how a user checks into the location of the event. This can be done by scanning the bar code on the ticket or using GPS. This flow chart also shows how you can connect super fan to social media notification;

FIG. 6 illustrates a flow chart that shows how a user can set up a method of payment;

FIG. 7 illustrates a flow chart that shows how a user can purchase tickets to upcoming events;

FIG. 8 illustrates a flow chart that shows how a user can find restaurants and make reservations;

FIG. 9 illustrates a flow chart that shows how a gaming and challenge element of super fan will connect to super fan;

FIG. 10 illustrates a flow chart that concessions can be connected that will enable the user to purchase food and beverages form their smart phone;

FIG. 11 illustrates a flow chart that will help the consumer navigate transportation and parking. This will also allow the consumer to pay for parking and or transportation;

FIG. 12 illustrates a flow chart that will enable the consumer to purchase merchandise, both virtual and real;

FIG. 13 illustrates a flow chart that will help the consumer discover nearby attraction that will enhance their experience;

FIG. 14 illustrates a flow chart that will enable to consumer to have an added value when attending a music event;

FIG. 15 illustrates a flow chart that will allow the consumer to take advantage of exciting combination offers;

FIG. 16 illustrates how points and levels are attained;

FIG. 17 illustrates how a super fan would view their account activity; and

FIG. 18 illustrates a flow chart that shows how an event manager can view who is at the event and how much they are spending etc.

### DETAILED DESCRIPTION OF PREFERRED EMBODIMENTS

The invention is defined by the appended claims. This description summarizes aspects of exemplary embodiments and should not be used to limit the claims.

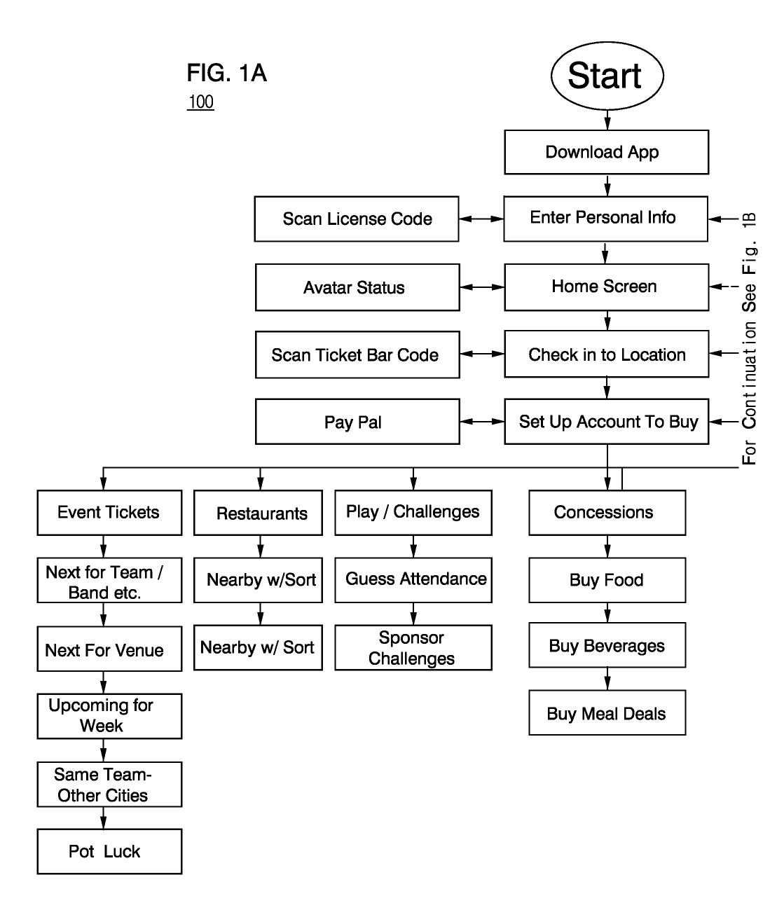

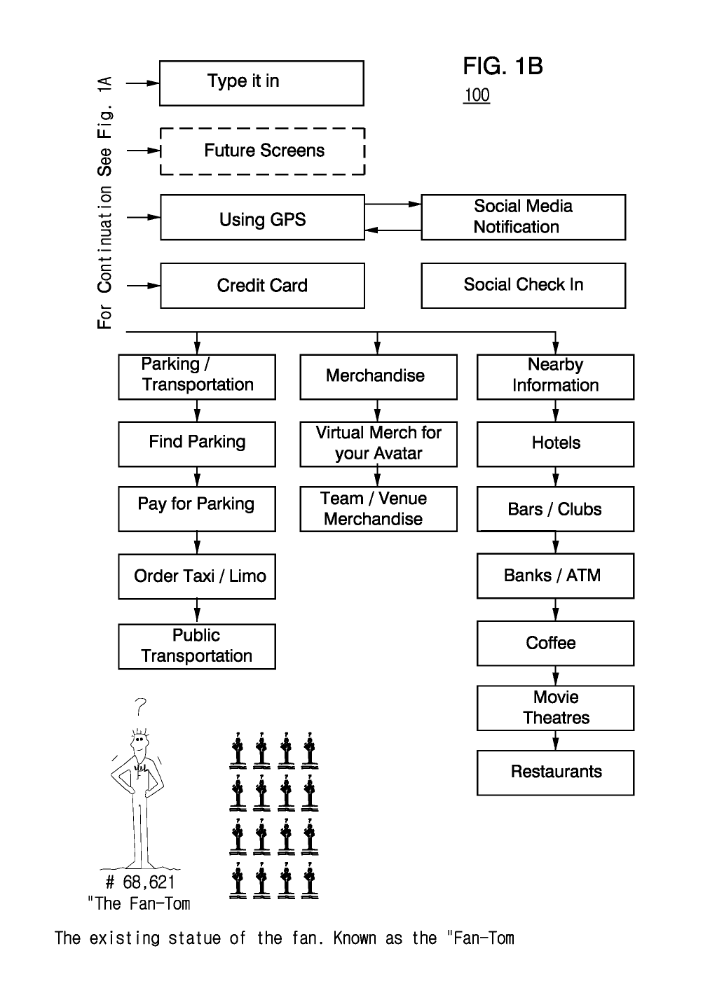

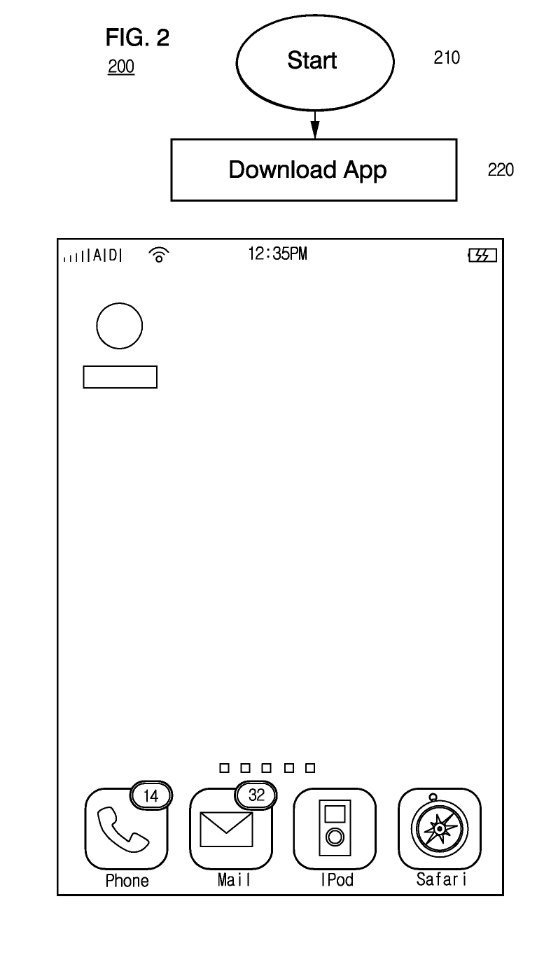

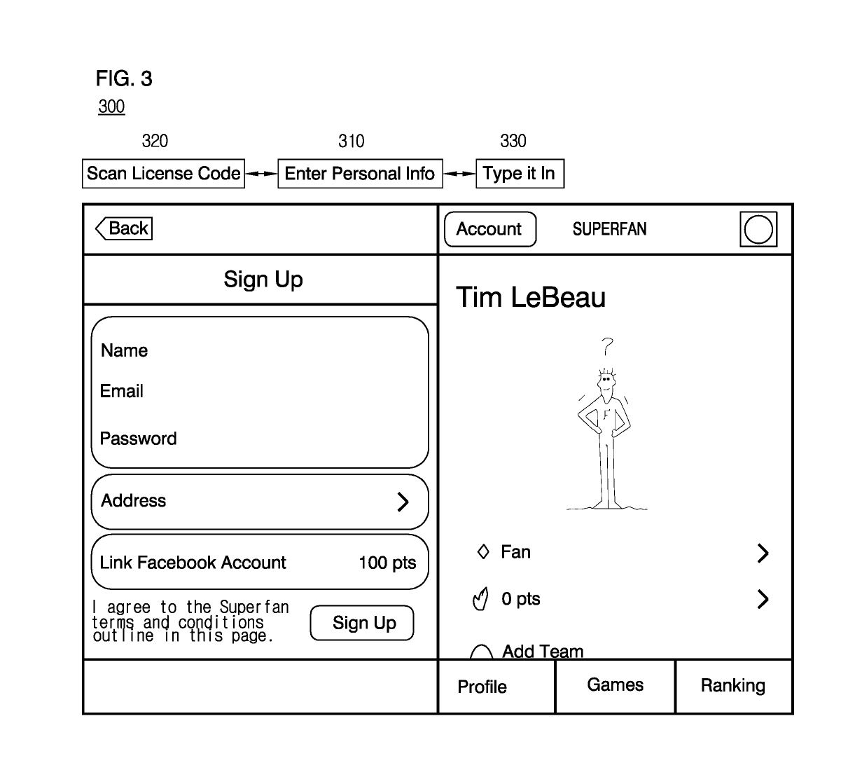

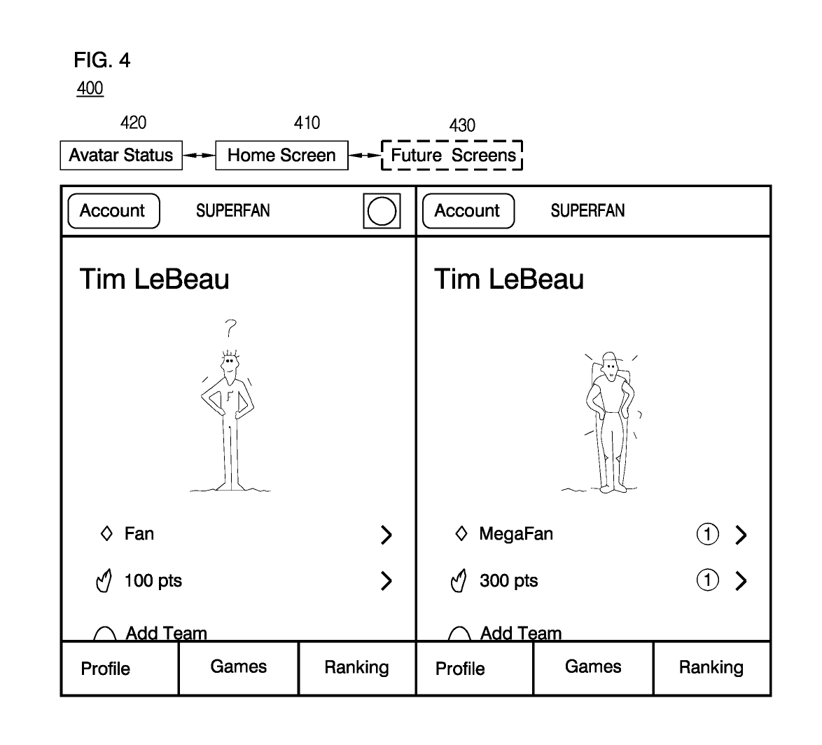

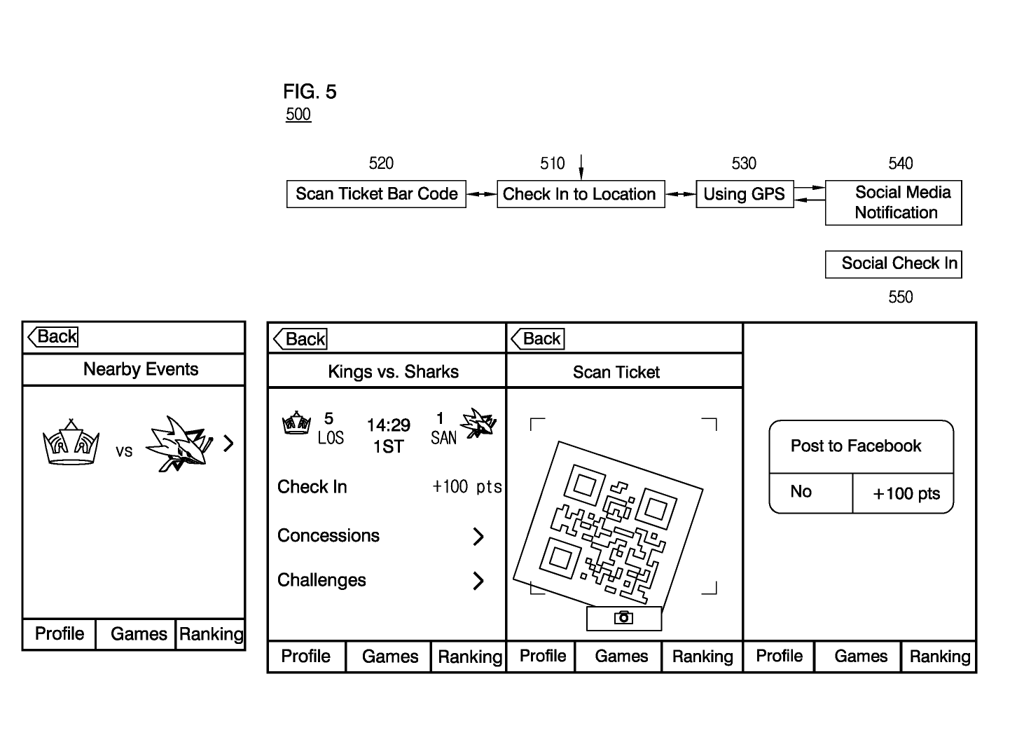

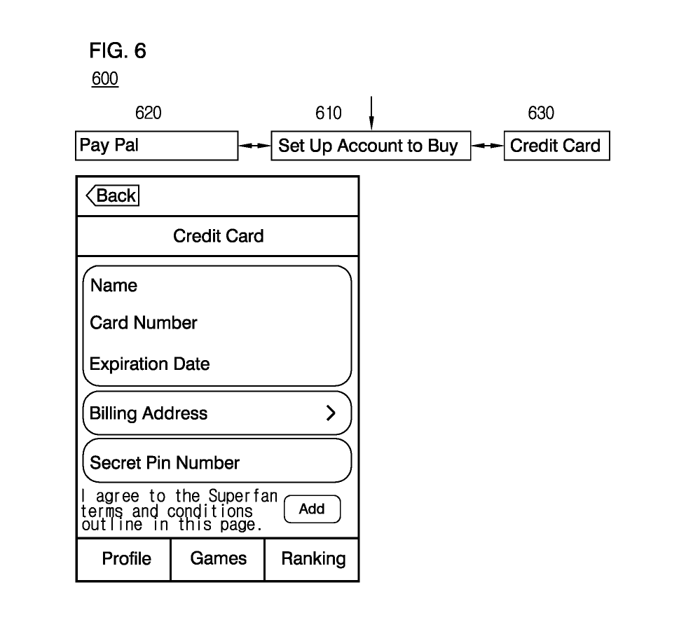

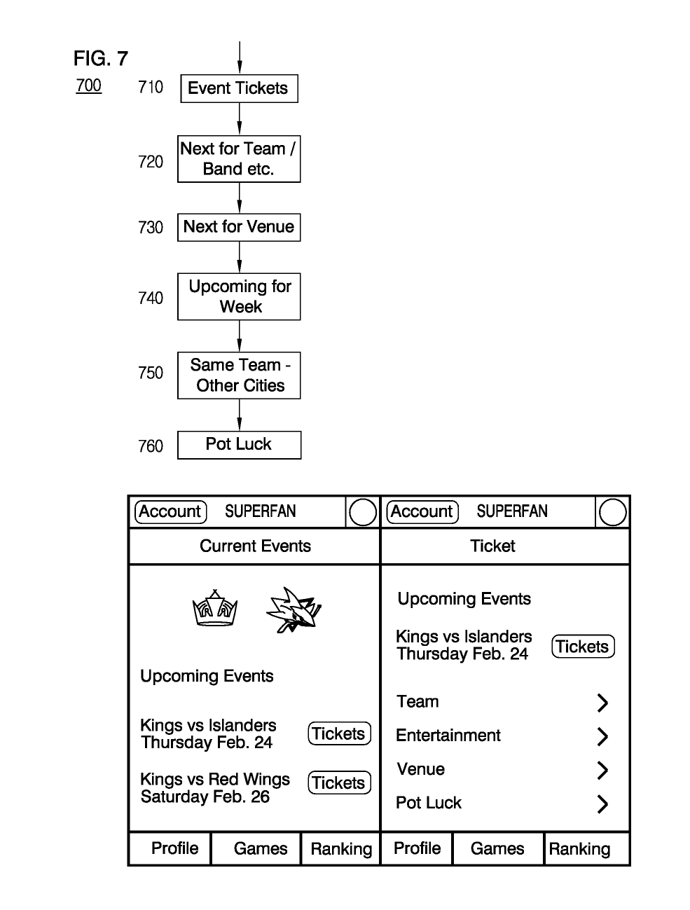

FIG. 1 illustrates a flow chart 100 in accordance with one embodiment of the present invention. As shown in FIG. 2, an application is selected in FIG. 220 that enables connection to the network via smart technology. This application can be either an iPhone application, use Android based technology, RIM technology or another version. After the application is loaded on the device, the user is required to set up personal information as shown in FIG. 3. This can be done by scanning their identification card FIG. 320 or by manually typing in the information FIG. 330. After the information is entered or upon return to the application at a later date, the user is presented with a home screen as FIG. 410. At this time the user can review their avatar status 420 or additional screens and options 430. When the user is in a location it will be asked to check into to the event 510. This can be accomplished by scanning a code from a ticket 520, or using GPS that would provide an option for the location 530. Once the location is identified, the user can also notify their social network that they have checked in 540 as well as join a social check in 550. This would use existing social media API (Application Programming Interface) protocol.

After checking in, the user has access to commerce offers or games. In order to enter into the commerce section, the user can set up their account 610 by using a pay pal type system 620 or a credit/debit card 630. After setting up the account or returning back to this screen and entering a PIN number the user has the ability to do several things. To buy tickets, the user can go via a ticket port that would link them to an existing third party interface that would allow them to buy event tickets 710, upcoming for specific type of entertainment 720, the upcoming events for the venue 730, upcoming events for the week 740, follow the entertainment to other cities 750 or participate in events that may interest the user called pot luck 760.

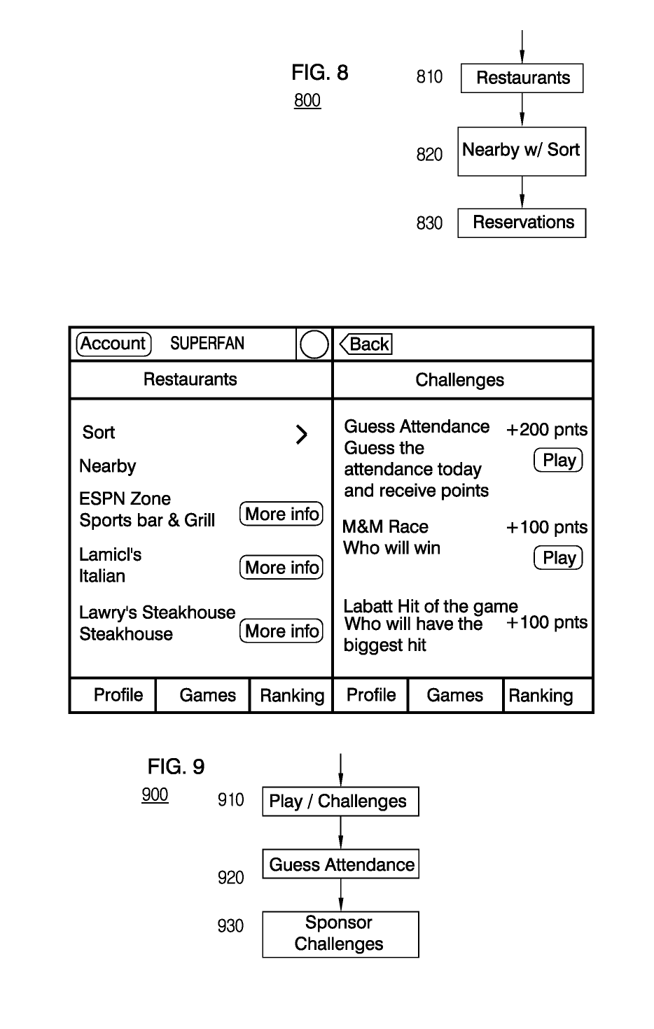

FIG. 8 shows how a user can search for local restaurants 810. They can sort by Name, Food type, decor, service or cost 820. This system will also allow the user to make reservations 830.

FIG. 9 shows how a user can play games and challenges 910. Some of these challenges can be but are not limited to guess the attendance 910 or a sponsored challenge that will award points paid for by the advertiser for recognition to the companies messaging. Other challenges and or games can be bolted onto this section.

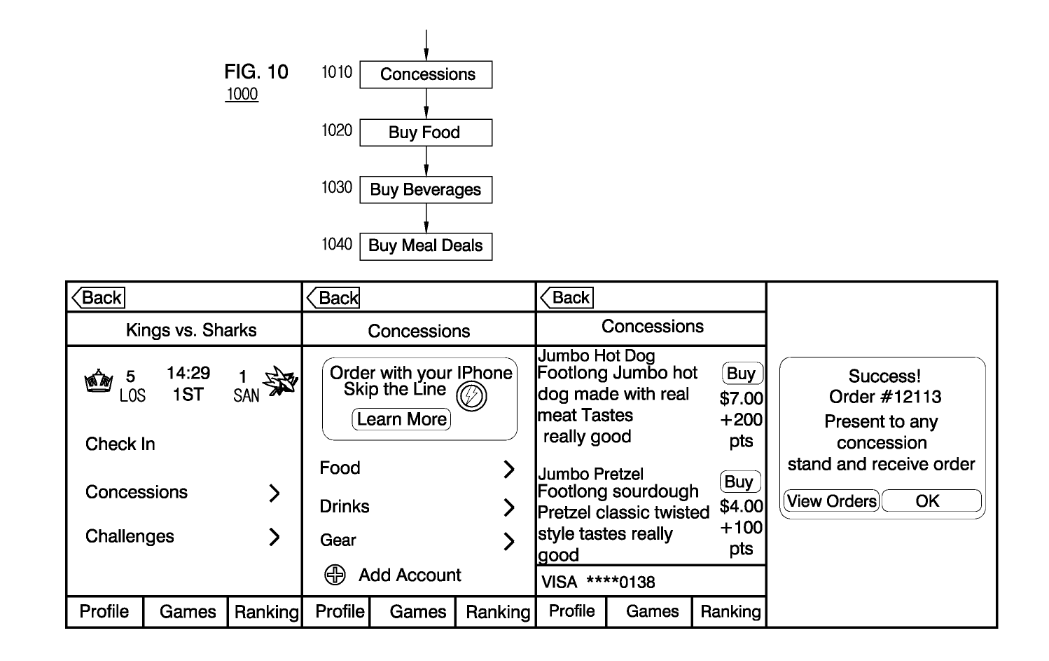

FIG. 10 shows how a user can order concessions during the event 1010. The user can buy food 1020, buy beverages 1030, buy meal deals 1040 and more. Depending on the venue, the user can place an order and have it delivered to their seat location either for free or a cost or can be notified that their order is ready and available for pick up at a designated concession stand. The proof of purchase for this transaction will be in the form of a code on the device that can be scanned by the concession stand or the delivery person. The concession will be paid for by the existing account. A summary of all activities can be available via e-mail or a web site for expense tracking by the user. Points are allocated to the user's account in accordance with money spent. Additionally, the user can enable a coupon feature that will allow sponsors to send incentives to the user. An example of this incentive could be to buy two XXX products and get a $1 off or buy a xxx and a zzz and get a mmm for free etc.

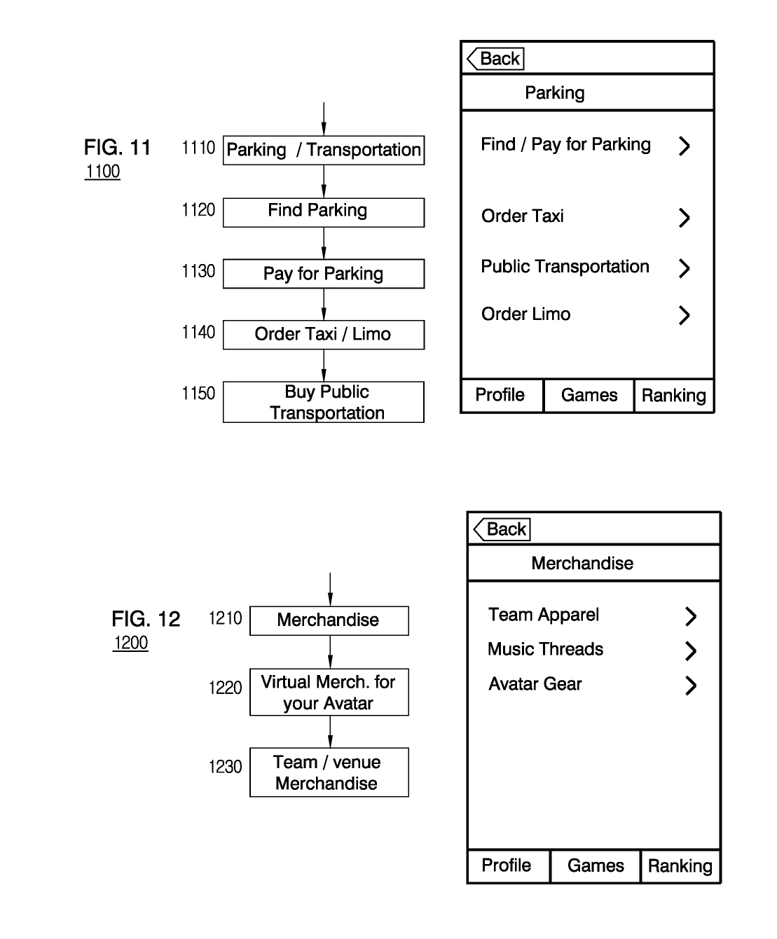

FIG. 11 shows how a user can arrange parking or transportation 1110. This will enable the user to find parking 1120 pay for parking 1130 order a taxi or limo 1140 or link into public transportation 1150. If the user chooses to pay for parking using this system, their account will be billed and they can use a code on their device to show proof of payment and avoid long lines.

FIG. 12 shows how a user can purchase merchandise 1210. The user can purchase virtual merchandise for their avatar 1220 or real merchandise 1230. This merchandise can be delivered to the seat, picked up in the team store via a will call system or delivered to an address identified by the user. The proof of purchase can be accomplished via scanning technology.

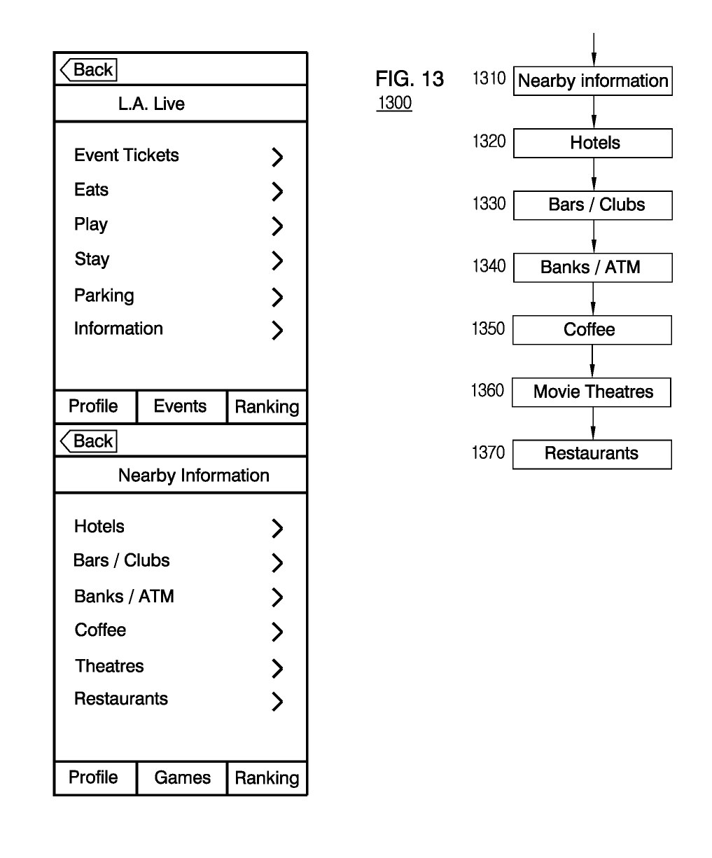

FIG. 13 shows how a user can find out nearby information that may be useful 1310. This can be to find a hotel 1320, bars or clubs 1330, banks or ATM's 1340, coffee shops 1350, movie theaters and listings 1360 or restaurants 1370.

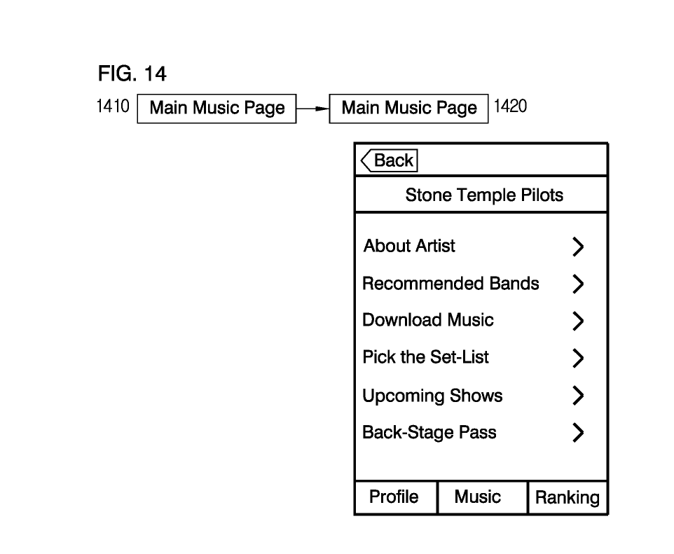

FIG. 14 shows how a music event can be connected to this application from the main screen. By going into the main music page 1410 the user can find out information on the performer 1420, they can use it for music discovery 1430, they can search music by the performer 1450. From here they can purchase the performer's product via iTunes or similar 1460 or download that day's performance 1440. Advanced features include having the fans pick the artists playlist 1470, search for upcoming shows 1480 or unlock special features in back stage pass 1490 like photos and interviews with the performer etc.

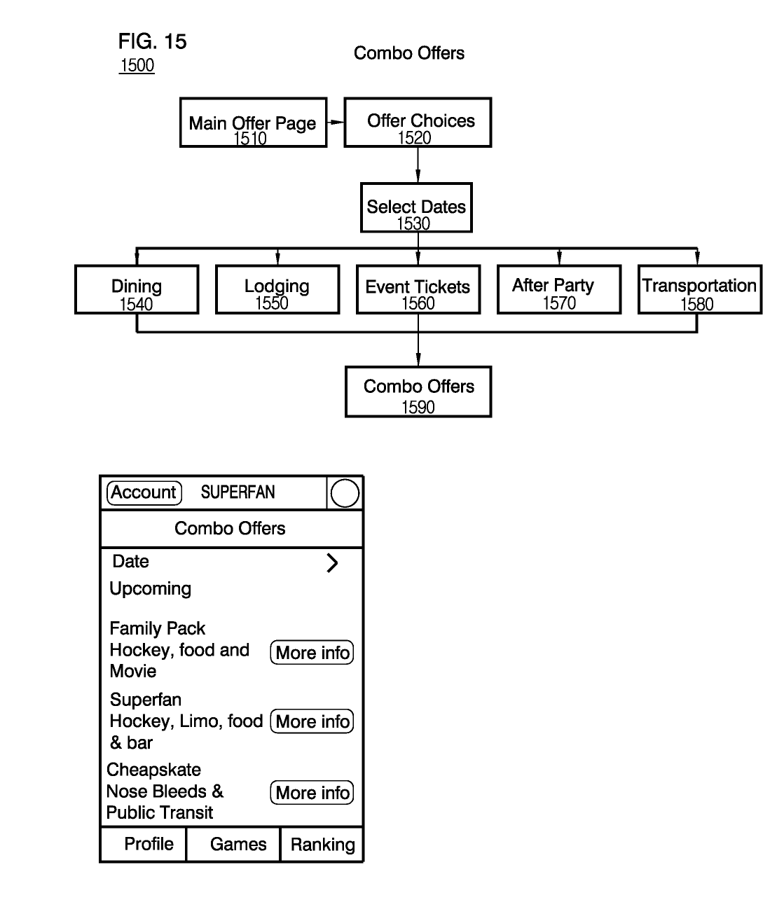

FIG. 15 shows how a user can create and take advantage of combination offers. This can be accessed through the main offer page 1510 and take the user to offer choices 1520. From there the user can select a date or a date range and location 1530 and then select if they want to combine dining 1540, lodging 1550, event tickets 1560, after event activities 1570 and transportation 1580. From there, combination offers will be presented to the user that they can use their device to purchase and download proof of purchase. Once the user's profile is identified, the event management can communicate with them to create special offers and not discounts for them. This could be by making special packages or by the special “12 o'clock shadow” that will combine offers to drive attendance and consumption at a venue or event. This will be done via electronic communication at noon on the day of an event to sell unsold tickets.

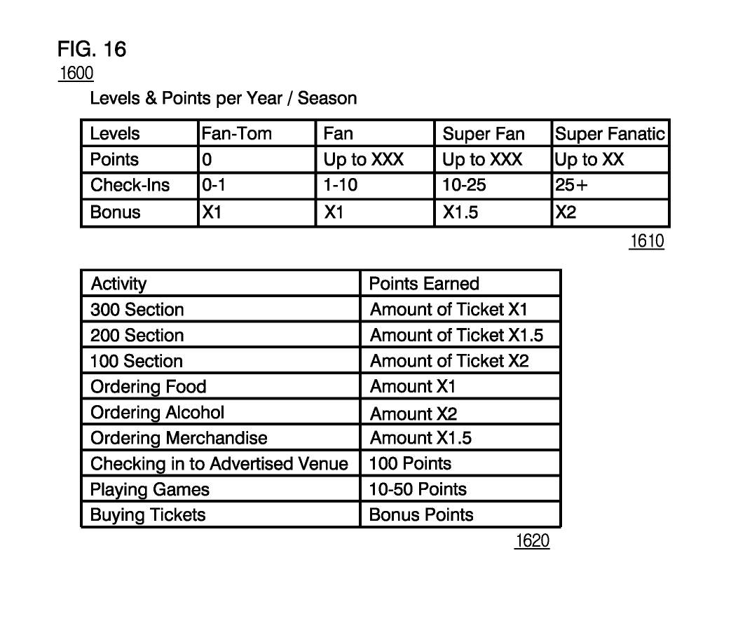

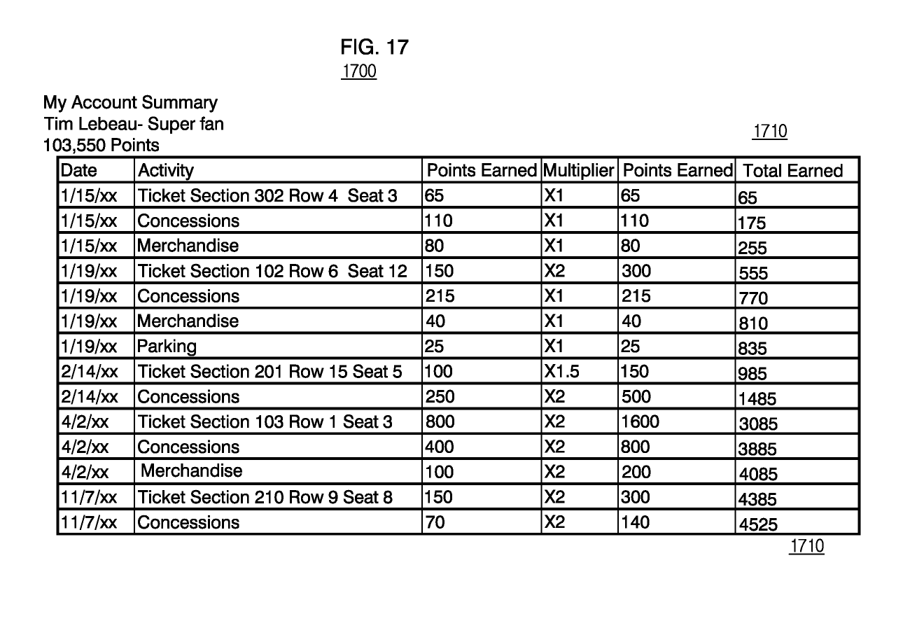

Another embodiment of the present invention relates to an incentive or loyalty program used in conjunction with this application. FIG. 16 illustrates this. In 1610, it shows the different levels that the user can achieve by performing different activities including gaining points or checking in to an event. After an achievement is made, the user gains additional rank and their rewards increase to match their loyalty. 1620 shows how additional points are earned depending on the activity or behavior performed by the user. This system can be modified depending on the event or the venue.

FIG. 1710 shows how a user can review their account of points earned. It will show the activity, the points earned the multiplier, total points earned and a running balance. These points can be used for many things.

Another embodiment of the present invention is an exchange program that allows customers to exchange points for goods or services either virtual or real.

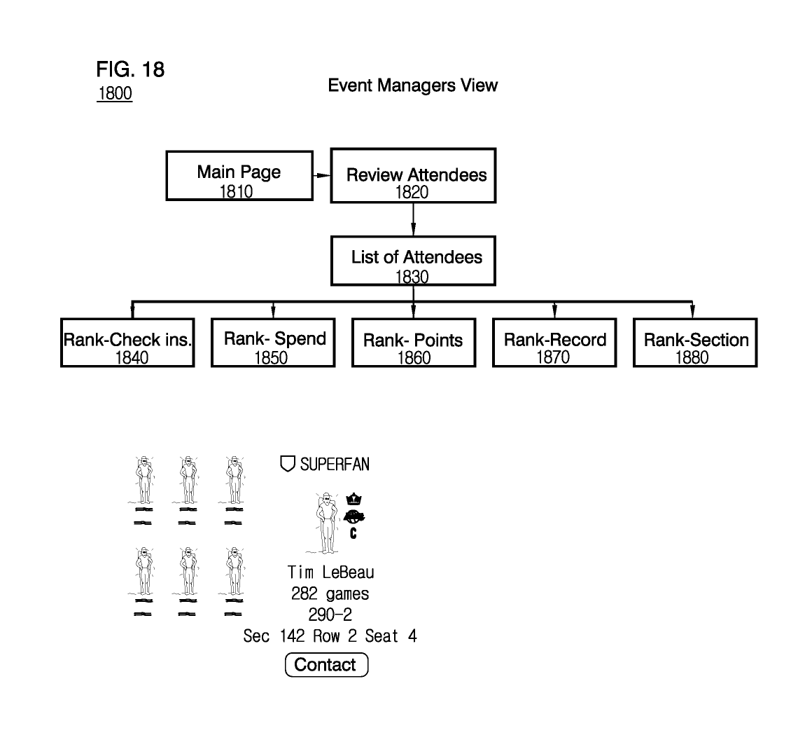

FIG. 18 shows how the event or facility manager can view the activity of the event on a manager's application. From their main page 1810 they can review all attendees 1820 in a list fashion 1830. They can sort the attendees by rank from check ins 1840, by rank from spend 1850, by rank from points 1860 from rank in their teams record when they were at the event 1870 or the above rank by their section 1880. Then they will be notified of the user's location so they can contact them and or give them additional recognition.

This system will use standard API for the different systems within each venue to facilitate the transactions.

Although exemplary embodiments of the invention have been described in detail above, those skilled in the art will readily appreciate that many additional modifications may be possible in the exemplary embodiment without materially departing from the novel teachings and advantages of the invention. Accordingly, these and all such modifications are intended to be included within the scope of this invention.

What is claimed is:

1. A method of using technology to integrate many of the activities that a participant does at an entertainment event.

2. The method of claim 1, including the step of checking in to an entertainment event and gaining awards and recognition for the act of being at the event.

3. The method of claim 1, including the step of entering virtual commerce at the event or with their affiliates.

4. The method of claim 1, including the step of purchasing tickets for the upcoming events or location for the event that you checked into or by using your profile to predict future events that the user may be interested in.

5. The method of claim 1, including the step of searching restaurants in connection for the event or location that the user has identified as their location.

6. The method of claim 1, including the step of playing games or activities at an entertainment event that gives rewards for participating and winning a game.

7. The method of claim 1, including the step of ordering concessions and having them delivered or picked up using a virtual commerce method.

8. The method of claim 1, including the step of discovery and payment of parking and transportation that is needed to attend or depart the event.

9. The method of claim 1, including the step of purchasing virtual or real merchandise from the venue and having it picked up or delivered.

10. The method of claim 1, including the step of discovery of nearby information in correlation to the event that the user is attending.

11. The method of claim 1, including the step of achieving a status and reward multiplier based on attendance and money spent at a venue.

12. The method of claim 1, including the step of stepping up the rewards in accordance with the activity.

13. The method of claim 1, including the step of recognition of achievement by the facility or event management.

14. The method of claim 1, including the step of using the points for rewards or recognition.
